(19) United States
(12) Patent Application Publication
(10) Pub. No.: US 2021/0171394 A1
(43) Pub. Date: Jun. 10, 2021

(54) METHOD AND APPARATUS FOR MANUFACTURING OPTICAL FIBER CABLE

(71) Applicant: FUJIKURA LTD., Tokyo (JP)

(72) Inventors: Kenji Yamashiro, Mie (JP); Hiroo Kawahara, Mie (JP)

(73) Assignee: FUJIKURA LTD., Tokyo (JP)

(21) Appl. No.: 16/770,288

(22) PCT Filed: Nov. 7, 2018
(86) PCT No.: PCT/JP2018/041357

§ 371 Date: Jun. 5, 2020

(30) Foreign Application Priority Data
Dec. 6, 2017 (JP) 2017-234407

(51) Int. Cl. C03C 25/6226; G02B 6/44; C03C 25/1065

(52) U.S. Cl. CPC C03C 25/6226; C03C 25/1065; G02B 6/4479

(57) ABSTRACT

A method of producing an optical fiber wire including a coating made of an ultraviolet curable resin, the method includes: a first irradiation step including applying first ultraviolet light to a point on the optical fiber wire where at least a portion of the ultraviolet curable resin is uncured; and a second irradiation step including applying second ultraviolet light to the point on the optical fiber wire where at least the portion is cured after the first irradiation step. The portion is a surface layer of the coating. A temperature of the optical fiber wire immediately before the second irradiation step is 50° C. or higher and 300° C. or lower.

### TECHNICAL FIELD

The present invention relates to a method of producing an optical fiber wire. The present invention also relates to an apparatus for producing an optical fiber wire.

### BACKGROUND

An optical fiber wire includes (1) an optical fiber bare wire made of glass and (2) a coating made of a resin and covering a side surface of the optical fiber wire. The coating serves to reduce a lateral pressure on the optical fiber bare wire to thereby improve resistance to external damage. In production of an optical fiber wire, it is common to apply an ultraviolet curable resin to a side surface of an optical fiber bare wire and then cure the ultraviolet curable resin by irradiation with ultraviolet light to form a coating.

It is known that production of an optical fiber wire involves a plurality of irradiation steps involving applying ultraviolet light. For example, Patent Literature 1 discloses a technique of carrying out a first irradiation step to cure a surface layer of an ultraviolet curable resin and then carrying out a second irradiation step to cure an inner layer. Patent Literature 2 discloses a technique of carrying out a first irradiation step to partially cure an ultraviolet curable resin of an optical fiber wire, causing the optical fiber wire to pass through a cooling pipe through which a cooling gas flows and thereby cooling the optical fiber wire, and then carrying out a second irradiation step.

However, according to conventional methods of producing an optical fiber wire, if curing of an inner layer of a coating of the optical fiber wire is insufficient, the optical fiber wire may suffer cracking of the coating after the optical fiber wire is produced.

### PATENT LITERATURE

[Patent Literature 1]
Japanese Patent Application Publication, Tokukai, No. 2014-77918 (Publication Date: May 1, 2014)

[Patent Literature 2]
Japanese Patent Application Publication, Tokukaihei, No. 10-297942 (Publication Date: Nov. 10, 1998)

### SUMMARY

One or more embodiments of the present invention provide a production method and a production apparatus for an optical fiber wire that is less likely to suffer cracking of a coating after the optical fiber wire is produced.

A method of producing an optical fiber wire in accordance with one or more embodiments of the present invention is a method of producing an optical fiber wire that includes a coating constituted by an ultraviolet curable resin, the method including: a first irradiation step including applying ultraviolet light to each point on the optical fiber wire in which at least a portion of the ultraviolet curable resin is in an uncured state, the portion constituting a surface layer of the coating; and a second irradiation step including applying ultraviolet light to each point on the optical fiber wire which is obtained from the first irradiation step and in which at least the portion constituting the surface layer of the coating is in a cured state, wherein a temperature of the optical fiber wire immediately before the second irradiation step is not lower than 50° C. and not higher than 300° C.

An apparatus for producing an optical fiber wire in accordance with one or more embodiments of the present invention is an apparatus for producing an optical fiber wire that includes a coating constituted by an ultraviolet curable resin, the apparatus including: a first irradiation section configured to apply ultraviolet light to each point on the optical fiber wire in which at least a portion of the ultraviolet curable resin is in an uncured state, the portion constituting a surface layer of the coating; and a second irradiation section configured to apply ultraviolet light to each point on the optical fiber wire which is obtained by application of the ultraviolet light by the first irradiation section and in which at least the portion constituting the surface layer of the coating is in a cured state, wherein a temperature of the optical fiber wire immediately before receiving the ultraviolet light from the second irradiation section is not lower than 50° C. and not higher than 300° C.

According to one or more embodiments of the present invention, it is possible to provide a production method and a production apparatus for an optical fiber wire that is less likely to suffer cracking of a coating after the optical fiber wire is produced.

### BRIEF DESCRIPTION OF THE DRAWINGS

FIG. 1 is a cross-sectional view illustrating a cross section of an optical fiber wire produced in one or more embodiments of the present invention.

FIG. 2 is a block diagram illustrating a configuration of an apparatus for producing an optical fiber wire in accordance with one or more embodiments of the present invention.

FIG. 3 is a chart showing examples of spectra of ultraviolet light emitted from a UV lamp of a primary irradiation section and ultraviolet light emitted from a UV LED of a secondary irradiation section in accordance with one or more embodiments of the present invention.

FIG. 4 is a cross-sectional view of a first irradiation unit included in the primary irradiation section in accordance with one or more embodiments of the present invention.

FIG. 5 is a cross-sectional view of a second irradiation unit included in the secondary irradiation section in accordance with one or more embodiments of the present invention.

FIG. 6 is a graph showing a relationship between the temperature of the optical fiber wire immediately before entry into the secondary irradiation section and the degree of cure of a primary coating after production, in accordance with one or more embodiments of the present invention.

FIG. 7 is a flowchart showing a method of producing an optical fiber wire in accordance with one or more embodiments of the present invention.

### DETAILED DESCRIPTION

The following description will discuss production apparatuses and production methods for an optical fiber in accordance with embodiments of the present invention. Note that configurations and steps each having the same function in the embodiments are given the same reference numerals, and descriptions on such configurations and steps will not be repeated.

[Configuration of Optical Fiber Wire]

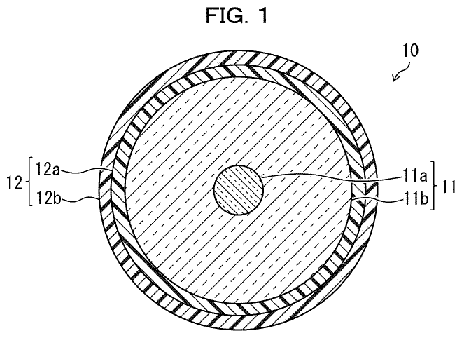

First, the following description discusses, with reference to FIG. 1, an optical fiber wire 10 produced by production apparatuses and production methods for an optical fiber in accordance with embodiments (described later) of the present invention. FIG. 1 is a cross-sectional view illustrating a cross section (which is perpendicular to optical axis) of the optical fiber wire 10.

The optical fiber wire 10 includes: an optical fiber bare wire 11 in the form of a circular rod; and a coating 12 that covers the side surface of the optical fiber bare wire 11.

The optical fiber bare wire 11 is constituted by: a core 11a in the form of a circular rod; and a cladding 11b that covers the side surface of the core 11a and that is in the form of a circular tube. The core 11a and the cladding 11b are each made of quartz glass. Note, however, that the quartz glass constituting the cladding 11b is lower in refractive index than the quartz glass constituting the core 11a. Such a difference in refractive index between the core 11a and the cladding 11b is formed by, for example: adding a dopant for increasing refractive index (e.g., germanium) to the quartz glass constituting the core 11a; or adding a dopant for reducing refractive index (e.g., fluorine) to the quartz glass constituting the cladding 11b. A reason why an arrangement in which the cladding 11b is lower in refractive index than the core 11a is employed is that this arrangement imparts the function of confining light within the core 11a to the optical fiber bare wire 11.

The coating 12 is constituted by: a primary coating 12a that covers the side surface (outer side surface of the cladding 11b) of the optical fiber bare wire 11 and that is in the form of a circular tube; and a secondary coating 12b that covers the outer side surface of the primary coating 12a and that is in the form of a circular tube. The primary coating 12a and the secondary coating 12b are each made of an ultraviolet curable resin. Note, however, that the ultraviolet curable resin constituting the primary coating 12a is lower in Young's modulus than the ultraviolet curable resin constituting the secondary coating 12b. Such a difference in Young's modulus between the primary coating 12a and the secondary coating 12b is formed by, for example: causing the degree of polymerization of the ultraviolet curable resin constituting the primary coating 12a to be different from that of the ultraviolet curable resin constituting the secondary coating 12b. A reason why an arrangement in which the Young's modulus of the secondary coating 12b is relatively high and the Young's modulus of the primary coating 12a is relatively low is employed is that this arrangement allows resistance to external damage to be improved by the secondary coating 12b which is hard and allows a shock absorbency to be improved by the primary coating 12a which is soft.

The ultraviolet curable resin constituting the primary coating 12a and the ultraviolet curable resin constituting the secondary coating 12b each contain a photopolymerization initiator. These ultraviolet curable resins start curing upon irradiation with ultraviolet light having a wavelength falling within the range of absorption wavelengths of the photopolymerization initiator. Note that the higher the temperature during carrying out curing is, the easier it is for the curing of the ultraviolet curable resin constituting the secondary coating 12b to advance and the more difficult it is for the curing of the ultraviolet curable resin constituting the primary coating 12a to advance. The lower the temperature during carrying out curing is, the more difficult it is for the curing of the ultraviolet curable resin constituting the secondary coating 12b to advance and the easier it is for the curing of the ultraviolet curable resin constituting the primary coating 12a to advance.

(Configuration of Apparatus for Producing Optical Fiber)

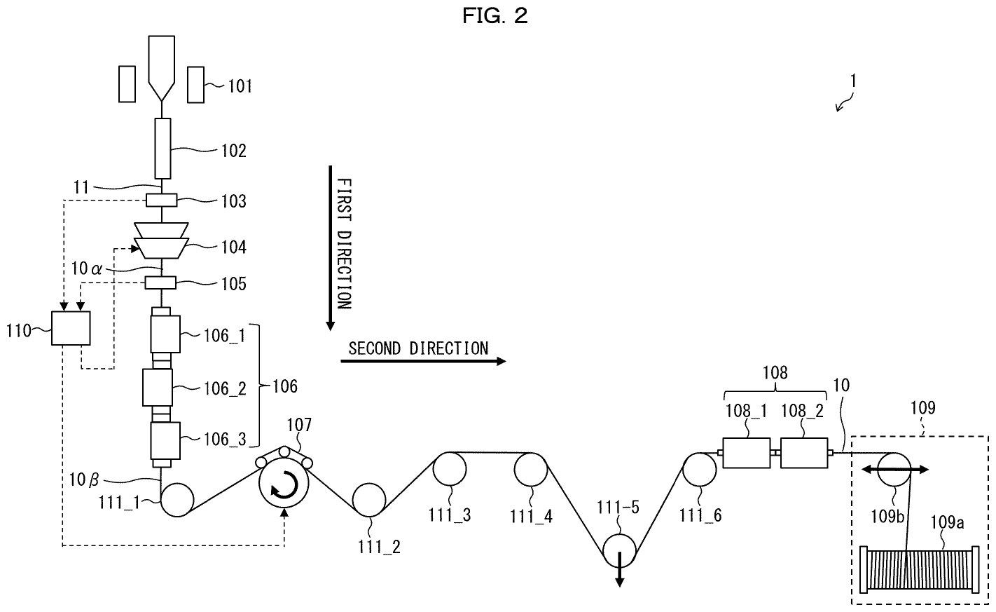

The following discusses a configuration of a production apparatus 1 in accordance with one or more embodiments with reference to FIG. 2. FIG. 2 is a block diagram illustrating a configuration of the production apparatus 1.

The production apparatus 1 is an apparatus for producing the optical fiber wire 10 (see FIG. 1), and includes a drawing section 101, a cooling section 102, a bare wire outer diameter measuring section 103, a coating section 104, a wire outer diameter measuring section 105, a primary irradiation section 106, a haul-off section 107, a secondary irradiation section 108, and a take-up section 109. These constituents are arranged in the order named along the path of advancement of the optical fiber wire 10. The production apparatus 1 also includes a control section 110 which controls the coating section 104 and the haul-off section 107 with reference to monitor signals obtained from the bare wire outer diameter measuring section 103 and the wire outer diameter measuring section 105. The production apparatus 1 also includes a plurality of pulleys 111_1 through 111_6. The path of advancement of the optical fiber wire 10 is defined by the pulleys 111_1 through 111_6.

Note that the primary irradiation section 106 constitutes an example of a first irradiation section in the present invention. The secondary irradiation section 108 constitutes an example of a second irradiation section in the present invention.

The drawing section 101 is a means to draw a preform which will constitute the optical fiber bare wire 11. In one or more embodiments, a furnace is used as the drawing section 101. The preform is heated and melted by the furnace. The melted preform is drawn by its own weight. Melting and extending a preform in this manner is referred to as “drawing”. The preform drawn by the drawing section 101 is sent into the cooling section 102 provided below the drawing section 101.

The cooling section 102 is a means to cool the preform which has been drawn. In one or more embodiments, a cooling cylinder is used as the cooling section 102. The preform which has been drawn is cooled and cured by a cooling gas flowing in the cooling cylinder. With this, the optical fiber bare wire 11 is obtained. The optical fiber bare wire 11, obtained in the cooling section 102, passes through the bare wire outer diameter measuring section 103 by which the outer diameter of the optical fiber bare wire 11 is measured, and then is sent into the coating section 104 provided below the cooling section 102.

The coating section 104 is a means to apply uncured ultraviolet curable resins, which will constitute the coating 12, to the side surface of the optical fiber bare wire 11. In one or more embodiments, a two-stage coating die, which consists of two coating dies stacked together, is used as the coating section 104. To the side surface of the optical fiber bare wire 11, an uncured ultraviolet curable resin which will constitute the primary coating 12a is applied by one of the two coating dies located upstream of the other. To the outer side surface of the primary coating 12a, an uncured ultraviolet curable resin which will constitute the secondary coating 12b is applied by the other of the two coating dies located downstream. With this, an optical fiber wire 10 whose primary coating 12a and secondary coating 12b are both in an uncured state is obtained. The optical fiber wire 10 in this state is hereinafter referred to as an optical fiber wire 10α. The optical fiber wire 10α obtained in the coating section 104 passes through the wire outer diameter measuring section 105 for measurement of the outer diameter thereof, and then is sent into the primary irradiation section 106 provided below the coating section 104.

Note that the thickness of the ultraviolet curable resins applied by the coating section 104 can be changed, and is controlled by the control section 110 in accordance with the outer diameter of the optical fiber wire 10α measured by the wire outer diameter measuring section 105. In a case where the outer diameter of the optical fiber wire 10α is less than a predetermined value, the control section 110 controls the coating section 104 to increase the thickness of the ultraviolet curable resins applied. On the contrary, in a case where the outer diameter of the optical fiber wire 10α is greater than the predetermined value, the control section 110 controls the coating section 104 to reduce the thickness of the ultraviolet curable resins applied. This makes it possible to make the outer diameter of the resulting optical fiber wire 10 closer to a predetermined value.

The primary irradiation section 106 is a means to irradiate the optical fiber wire 10α with ultraviolet light (to apply ultraviolet light to the optical fiber wire 10α) with use of one or more UV lamps (one or more ultraviolet lamps) in a low-oxygen atmosphere. In one or more embodiments, n (n is a natural number of 1 or more) UV lamp units 106_1 through 106_n, each including a UV lamp as a light source, are used as the primary irradiation section 106. A configuration of each of the UV lamp units 106_i (i is a natural number of 1 or more and n or less) will be described later in detail with reference to another drawing. Note that, although FIG. 2 shows an example in which n=3, the number of the UV lamp units 106_i included in the primary irradiation section 106 may be any number.

Upon irradiation with ultraviolet light from the UV lamps of the primary irradiation section 106, the ultraviolet curable resins that will constitute the coating 12 cure in a manner such that outer portions thereof cure first. Through this irradiation with ultraviolet light from the UV lamps of the primary irradiation section 106, mainly the ultraviolet curable resin constituting the secondary coating 12b cures. Note, however, that, as of the end of the ultraviolet irradiation using the UV lamps of the primary irradiation section 106, it is only necessary that at least a portion constituting the surface layer of the secondary coating 12b has sufficiently cured, and the other portions of the ultraviolet curable resins may remain in an uncured or semi-cured state. The optical fiber wire 10 in this state is hereinafter referred to as an optical fiber wire 10β. The optical fiber wire 10β obtained in the primary irradiation section 106 passes over the pulley 111_1, and then is sent to the haul-off section 107. The pulley 111_1 serves as a turn pulley that changes the direction of advancement of the optical fiber wire 10β from a first direction (which is parallel to the direction of gravitational force, downward direction in FIG. 2) to a second direction (which is perpendicular to the direction of gravitational force, rightward direction in FIG. 2).

The haul-off section 107 is a means to pull on the optical fiber wire 10β at a specific pulling speed. As used herein, the term “pulling speed” refers to the length of the optical fiber wire 10β pulled on by the haul-off section 107 per unit time. In one or more embodiments, a capstan is used as the haul-off section 107. The optical fiber wire 10β, pulled on by the haul-off section 107, passes over the pulleys 111_2 through 111_6 and then is sent to the secondary irradiation section 108 provided lateral to the haul-off section 107. Note, here, that the pulley 111_5 is a dancer pulley that is capable of being displaced parallel to the first direction (displaced in upward and downward directions in FIG. 2). When this pulley 111_5 is biased in the first direction (downward direction in FIG. 2), tension is applied to the optical fiber wire 10β.

Note that the pulling speed at which the haul-off section 107 pulls on the optical fiber wire 10β can be changed, and is controlled by the control section 110 in accordance with the outer diameter of the optical fiber bare wire 11 measured by the bare wire outer diameter measuring section 103. In a case where the outer diameter of the optical fiber bare wire 11 is less than a predetermined value, the control section 110 controls the haul-off section 107 to reduce the pulling speed. On the contrary, in a case where the outer diameter of the optical fiber bare wire 11 is greater than the predetermined value, the control section 110 controls the haul-off section 107 to increase the pulling speed. This makes it possible to make the outer diameter of the resulting optical fiber bare wire 11 closer to the predetermined value.

The secondary irradiation section 108 is a means to irradiate the optical fiber wire 10β with ultraviolet light (to apply ultraviolet light to the optical fiber wire 10β) with use of one or more UV LEDs (one or more ultraviolet light emitting diodes). In one or more embodiments, m (m is a natural number of 1 or more) UV LED units 108_1 through 108_m, each including a UV LED as a light source, are used as the secondary irradiation section 108. A configuration of each of the UV LED units 108_j (j is a natural number of 1 or more and m or less) will be described later in detail with reference to another drawing. Note that, although FIG. 2 shows an example in which m=2, the number of the UV LED units 108_j included in the secondary irradiation section 108 may be any number.

Of the ultraviolet curable resins that will constitute the coating 12, a portion which has not sufficiently cured even after the irradiation with ultraviolet light from the UV lamps of the primary irradiation section 106 is allowed to cure to its full extent by irradiation with ultraviolet light from the UV LEDs of the secondary irradiation section 108. Through the irradiation with ultraviolet light from the UV LEDs of the secondary irradiation section 108, mainly the ultraviolet curable resin constituting the primary coating 12a cures. With this, the optical fiber wire 10 is obtained. The optical fiber wire 10 obtained in the secondary irradiation section 108 is sent to the take-up section 109.

The take-up section 109 is a means to take up the optical fiber wire 10. In one or more embodiments, a take-up drum 109a having a rotation axis parallel to the second direction and a pulley 109b capable of being displaced parallel to the second direction are used as the take-up section 109. The take-up drum 109a is rotated while the pulley 109b is translated back and forth along the second direction, and thereby the optical fiber wire 10 is wound around the take-up drum 109a in a uniform manner.

As has been described, in the production apparatus 1, UV lamps are used as light sources of the primary irradiation section 106, whereas UV LEDs are used as light sources of the secondary irradiation section 108. A reason therefor is as follows.

UV LEDs consume less electric power than UV lamps. Furthermore, UV LEDs are less likely to generate heat, and therefore enable simplification of cooling equipment and, in turn, make it possible to further reduce power consumption during operation. In addition, UV LEDs are advantageous in that it is possible to reduce the deterioration of ultraviolet curable resin that would occur under high temperature environment. The use of UV LEDs as light sources of the primary irradiation section 106, however, entails the following situation.

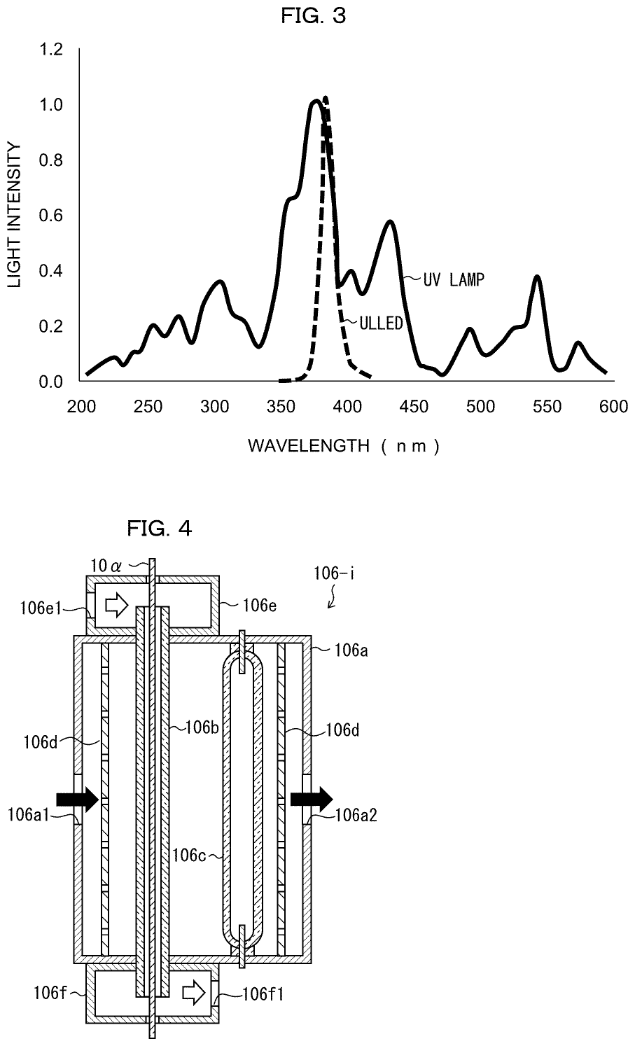

Specifically, as shown in FIG. 3, ultraviolet light emitted by a UV LED has a narrower spectrum width than ultraviolet light emitted by a UV lamp. Therefore, the peak wavelength of the UV LED is likely to be different from the absorption wavelengths of the photopolymerization initiator contained in the secondary coating 12b. In addition, the secondary coating 12b tends to cure more rapidly when the temperature of the fiber during curing is higher. Therefore, if UV LEDs are used in the primary irradiation section 106, the primary irradiation section 106 will probably be incapable of allowing the portion, which constitutes the surface layer of the secondary coating 12b, of the ultraviolet curable resin to sufficiently cure. This leads to a situation in that, when the optical fiber wire 10β makes contact with the pulley 111_1, the surface of the secondary coating 12b adheres to the pulley 111_1 and comes off.

In view of this, the production apparatus 1 employs an arrangement in which UV lamps are used as light sources of the primary irradiation section 106, and thereby avoids such a situation.

The primary irradiation section 106 of the production apparatus 1 further employs the following arrangement.

Specifically, the primary irradiation section 106 irradiates the optical fiber wire 10α with ultraviolet light with use of the UV lamps in a low-oxygen atmosphere containing oxygen at a concentration of not more than 2%. This is to prevent hindering of the curing of the ultraviolet curable resin that would otherwise be caused by oxygen. In particular, the primary irradiation section 106 is configured such that an inert gas, containing oxygen at a concentration of not more than 2%, flows through a quartz pipe which is passed through by the optical fiber wire 10α irradiated with ultraviolet light emitted from the UV lamps.

The primary irradiation section 106 is configured such that each point on the optical fiber wire 10α is irradiated with ultraviolet light from the UV lamps for not less than 0.01 seconds. This time period, which is “irradiation time”, is the time for at least a portion, which constitutes the surface layer of the secondary coating 12b, of the ultraviolet curable resin to sufficiently cure. Note that the irradiation time is the time from when a point on the optical fiber wire 10α enters an area irradiated with ultraviolet light from the primary irradiation section 106 (such an area may be hereinafter referred to as “irradiation area”) to when the point on the optical fiber wire 10α goes out of the irradiation area. For example, assume that the drawing speed is 3000 m/min. In this case, in order to ensure irradiation time of 0.01 seconds, it is only necessary to employ an arrangement in which the length of the irradiation area, in which the irradiation by the primary irradiation section 106 is carried out in a low-oxygen atmosphere, is not less than 0.6 m.

The primary irradiation section 106 is further configured such that each point on the optical fiber wire 10α is irradiated with ultraviolet light from the UV lamps for not more than 0.07 seconds. This is the irradiation time that prevents deterioration of the ultraviolet curable resin that would be caused by a high temperature environment resulting from use of the UV lamps, while ensuring sufficient curing of at least a portion, which constitutes the surface layer of the secondary coating 12b, of the ultraviolet curable resin. For example, assume that the drawing speed is 1000 m/min. In this case, in order to ensure irradiation time of not more than 0.07 seconds, it is only necessary to employ an arrangement in which the length of the irradiation area, in which irradiation by the primary irradiation section 106 is carried out in a low-oxygen atmosphere, is not more than 1.2 m.

The secondary irradiation section 108 of the production apparatus 1 may further employ the following arrangement.

Specifically, the UV LEDs included in the secondary irradiation section 108 may be UV LEDs that emit ultraviolet light whose wavelength is included in the absorption wavelengths of the photopolymerization initiator contained in the ultraviolet curable resin constituting the primary coating 12a. A reason therefor is as follows. In one or more embodiments, it is likely that, in the optical fiber wire 10β which has passed through the primary irradiation section 106, the ultraviolet curable resin constituting the secondary coating 12a has cured to some extent. It is inferred from this that, among the ultraviolet curable resins that will constitute the coating 12 of the optical fiber wire 10β, an insufficiently cured portion is mainly the ultraviolet curable resin constituting the primary coating 12a.

(Configurations of UV Lamp Unit and UV LED Unit)

The following description will discuss configurations of the UV lamp units 106_i included in the primary irradiation section 106, with reference to FIG. 4. FIG. 4 is a cross-sectional view of one of the UV lamp units 106_i.

The UV lamp unit 106_i includes: a housing 106a; a quartz pipe 106b that penetrates through the housing 106a; a UV lamp 106c contained in the housing 106a; and a reflecting plate 106d that is contained in the housing 106a and that surrounds the quartz pipe 106b and the UV lamp 106c. The UV lamp 106c is, for example, a metal halide lamp. Ultraviolet light emitted from the UV lamp 106c is directly applied to the optical fiber wire 10α advancing through the quartz pipe 106b or is reflected by the reflecting plate 106d and then is applied to the optical fiber wire 10a.

Note that the housing 106a has: a gas inlet 106a1 through which cooling gas is supplied into the housing 106a; and a gas outlet 106a2 through which the cooling gas is discharged from the housing 106a. The UV lamp 106c contained in the housing 106a is cooled by the cooling gas.

The UV lamp unit 106_i further includes: an upper cap 106e for accommodating the top end of the quartz pipe 106b projecting upward from the housing 106a; and a lower cap 106f for accommodating the bottom end of the quartz pipe 106b projecting downward from the housing 106a. The upper cap 106e has a gas inlet 106e1 through which an inert gas containing oxygen at low concentration is supplied into the upper cap 106e. The lower cap 106f has a gas outlet 106f1 through which the inert gas is discharged from the lower cap 106f. The inert gas is, for example, nitrogen, argon, or helium. The interior of the upper cap 106e, the interior of the quartz pipe 106b, and the interior of the lower cap 106f are filled with the inert gas. That is, the optical fiber wire 10α, which advances through the quartz pipe 106b, is irradiated with ultraviolet light in a low-oxygen atmosphere.

In one or more embodiments, such UV lamp units 106_1 through 3 are arranged in sequence. The total length of the areas irradiated with ultraviolet light from the UV lamp units 106_i is such a length that irradiation time of not less than 0.01 seconds and not more than 0.07 seconds is achieved. This length can change with changes in pulling speed.

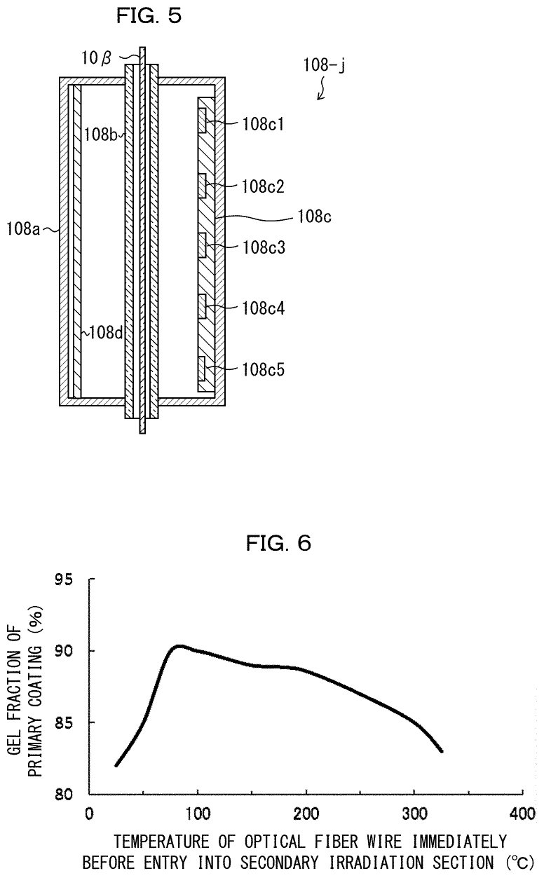

The following description will discuss configurations of the UV LED units 108_j included in the secondary irradiation section 108, with reference to FIG. 5. FIG. 5 is a cross-sectional view of one of the UV LED units 108_j.

The UV LED unit 108_j includes: a housing 108a; a quartz pipe 108b that penetrates through the housing 108a; a UV LED bar 108c contained in the housing 108a; and a reflecting plate 108d that is contained in the housing 108a and that surrounds the quartz pipe 108b so as to face the UV LED bar 108c. The UV LED bar 108c is an ultraviolet light source including a plurality of UV LEDs 108c1 through 108c5 arranged in a straight line. Ultraviolet light emitted from the UV LED bar 108c is directly applied to the optical fiber wire 10β advancing through the quartz pipe 108b or is reflected by the reflecting plate 108d and then is applied to the optical fiber wire 10β.

(Temperature of Optical Fiber Wire 10β Immediately Before Entry into Secondary Irradiation Section 108)

The temperature of the optical fiber wire 10β immediately before entry into the secondary irradiation section 108 may not be lower than 50° C. or higher than 300° C. To achieve this, one or more embodiments employ an arrangement in which the length of the path of advancement of the optical fiber wire 10β, from the primary irradiation section 106 to the secondary irradiation section 108, is long enough so that the optical fiber wire 10β is allowed to naturally cool to have a temperature not lower than 50° C. and not higher than 300° C. immediately before entry into the secondary irradiation section 108. Note that the rate of temperature decrease, resulting from natural cooling, of the optical fiber wire 10β is, for example, not less than 400° C. per second and not more than 1400° C. per second. However, the rate of temperature decrease, resulting from natural cooling, of the optical fiber wire 10β changes with changes in drawing speed. Therefore, the length of the path of advancement of the optical fiber wire 10β from the primary irradiation section 106 to the secondary irradiation section 108 is also set to a value corresponding to the drawing speed.

The following description will discuss a reason why the temperature of the optical fiber wire 10β immediately before entry into the secondary irradiation section 108 may not be lower than 50° C. or higher than 300° C., with reference to FIG. 6. FIG. 6 is a graph showing a relationship between the temperature of the optical fiber wire 10β immediately before entry into the secondary irradiation section 108 and the degree of cure of the primary coating 12a constituting the produced optical fiber wire 10. The indicator used here to indicate the degree of cure of the primary coating 12a is gel fraction. The graph shown in FIG. 6 indicates that, when the temperature of the optical fiber wire 10β immediately before entry into the secondary irradiation section 108 is not lower than 50° C. and not higher than 300° C., the gel fraction of the primary coating 12a is not less than 85%.

If the optical fiber wire 10 after production receives a lateral pressure, the coating 12 may crack. According to the findings made by the inventors of the present invention, (1) when the gel fraction of the primary coating 12a is less than 80%, several tens of percentage of optical fiber wires 10 have cracking in their coating 12, (2) when the gel fraction of the primary coating 12a is not less than 80% and less than 85%, several percentage of optical fiber wires 10 have cracking in their coating 12, and (3) when the gel fraction of the primary coating 12a is not less than 85%, no optical fiber wires 10 have cracking in their coating 12. As such, in cases where the temperature of the optical fiber wire 10β immediately before entry into the secondary irradiation section 108 is not lower than 50° C. and not higher than 300° C., the gel fraction of the primary coating 12a is not less than 85%, resulting in the prevention of cracking that would otherwise occur in the coating 12.

The temperature of the optical fiber wire 10β immediately before entry into the secondary irradiation section 108 may not be lower than 63° C. or higher than 100° C. In such cases, the gel fraction of the primary coating 12a further increases, resulting in the presentation of cracking that would otherwise occur in the coating 12, with more certainty.

(Temperature of Optical Fiber Wire 10β Immediately after Passage Through Primary Irradiation Section 106)

The temperature of the optical fiber wire 10β immediately after the passage through the primary irradiation section 106 may not be higher than 300° C. This is because, provided that the temperature of the optical fiber wire 10β immediately after the passage through the primary irradiation section 106 is not higher than 300° C., the temperature of the optical fiber wire 10β immediately before entry into the secondary irradiation section 108 will definitely be not higher than 300° C.

Note that the rate of temperature increase of the optical fiber wire 10α in the primary irradiation section 106 is not less than 3000° C./sec. and not more than 24000° C./sec. For example, in a case where the rate of temperature increase of the optical fiber wire 10α in the primary irradiation section 106 is 3000° C./sec., the drawing speed is set so that the time taken for the optical fiber wire 10α to pass through the primary irradiation section 106 is 0.1 seconds or shorter. This makes it possible to keep the temperature of the optical fiber wire 10β, immediately after the passage through the primary irradiation section 106, not higher than 300° C. Alternatively, in a case where the rate of temperature increase of the optical fiber wire 10α in the primary irradiation section 106 is 24000° C./sec., the drawing speed is set so that the time taken for the optical fiber wire 10α to pass through the primary irradiation section 106 is 0.0125 seconds or shorter. This makes it possible to keep the temperature of the optical fiber wire 10β, immediately after the passage through the primary irradiation section 106, not higher than 300° C.

(Production Method for Optical Fiber Wire)

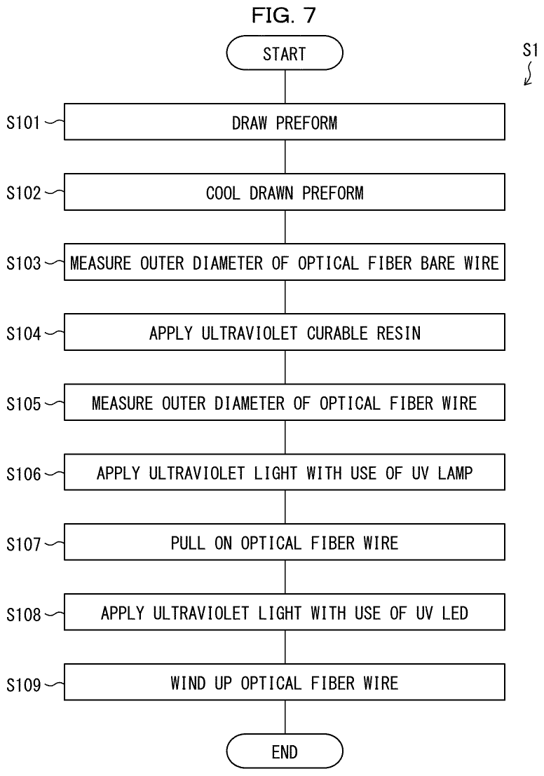

The following description will discuss a production method 51 for an optical fiber wire 10 in accordance with one or more embodiments of the present invention, with reference to FIG. 7. FIG. 7 is a flowchart showing the production method 51 for an optical fiber wire 10. The production method 51 is a method for producing the optical fiber wire 10 (see FIG. 1), and includes the following steps S101 through S109.

Step S101: The drawing section 101 draws a preform which will constitute the optical fiber bare wire 11.

Step S102: The cooling section 102 cools the preform drawn in step S101. This provides the optical fiber bare wire 11.

Step S103: The bare wire outer diameter measuring section 103 measures the outer diameter of the optical fiber bare wire 11 obtained in step S102, and supplies, to the control section 110, a monitor signal indicative of the measured outer diameter.

Step S104 (coating step): The coating section 104 applies, to the side surface of the optical fiber bare wire 11 whose outer diameter has been measured in step S103, uncured ultraviolet curable resins that will constitute the coating 12. Specifically, the coating section 104 carries out both of the following operations: (i) the operation of applying, to the outer side surface of the optical fiber bare wire 11, an uncured ultraviolet curable resin which will constitute the primary coating 12a; and (ii) the operation of applying, to the outer side surface of the primary coating 12a, an uncured ultraviolet curable resin which will constitute the secondary coating 12b. This provides the optical fiber wire 10a.

Note that the thickness of the ultraviolet curable resins applied in step S104 is adjusted by control by the control section 110 in accordance with the outer diameter of the optical fiber wire 10α measured in step S105 (described below).

Step S105: The wire outer diameter measuring section 105 measures the outer diameter of the optical fiber wire 10α obtained in step S104, and supplies, to the control section 110, a monitor signal indicative of the measured outer diameter.

Step S106 (first irradiation step): The primary irradiation section 106 irradiates the optical fiber wire 10α, obtained in step S105, with ultraviolet light with use of the one or more UV lamps. With this, the ultraviolet curable resin that will constitute the secondary coating 12b mainly cures, and the optical fiber wire 10β is obtained. In this step, at least a portion, which constitutes the surface layer of the secondary coating 12b, of the ultraviolet curable resin is allowed to sufficiently cure. The temperature of the optical fiber wire 10β obtained here is not higher than 300° C.

Step S107: The haul-off section 107 pulls on the optical fiber wire 10β, obtained in step S106, at a specific pulling speed.

Note that the pulling speed at which the optical fiber wire 10β is pulled on in step S107 is adjusted by control by the control section 110 in accordance with the outer diameter of the optical fiber bare wire 11 measured in the foregoing step S103.

Step S108 (second irradiation step): The secondary irradiation section 108 irradiates the optical fiber wire 10β, pulled on in step S107, with ultraviolet light with use of the one or more UV LEDs. With this, the ultraviolet curable resin that will constitute the primary coating 12a mainly cures, and the optical fiber wire 10 is obtained. Note that the temperature of the optical fiber wire 10β immediately before step S108 is carried out is not lower than 50° C. and not higher than 300° C., because the optical fiber wire 10β is allowed to naturally cool after step S106.

Step S109: The take-up section 109 takes up the optical fiber wire 10, obtained in step S108, around the take-up drum 109a. This provides the optical fiber wire 10 wound around the take-up drum 109a.

Note that, in the foregoing step S106, the ultraviolet irradiation by the primary irradiation section 106 using the UV lamps is carried out for not less than 0.01 seconds in a low-oxygen atmosphere containing oxygen at a concentration of not more than 2%, as described earlier.

As has been described, according to one or more embodiments, each point on an optical fiber wire, in which at least a portion, containing the surface layer, of the ultraviolet curable resin constituting the coating is in an uncured state, is irradiated with ultraviolet light from UV lamps for not less than 0.01 seconds in a low-oxygen atmosphere containing oxygen at a concentration of not more than 2%. Then, according to one or more embodiments, each point on the optical fiber wire is irradiated with ultraviolet light from UV LEDs.

Note, here, that the absorption wavelengths of the photopolymerization initiator contained in the secondary coating 12b are highly likely to be included in the wavelength range of the ultraviolet light emitted from the UV lamps, which has a wide spectrum width. Also note that the secondary coating 12b tends to cure more rapidly when the temperature of the fiber during curing is higher.

Therefore, according to one or more embodiments, it is possible to allow at least the surface layer of the secondary coating 12b to sufficiently cure by irradiation in an early stage of the production process of the optical fiber wire 10. This makes it possible, according to one or more embodiments, to produce the optical fiber wire 10 that is less likely to lose surface quality than conventional techniques, with use of the production apparatus 1 configured to apply the primary coating 12a and the secondary coating 12b in a single step.

(Variations)

The discussions in the above-described embodiments are based on the assumption that, in each of the UV lamp units 106_1 through 106_3 included in the primary irradiation section 106, irradiation is carried out in a low-oxygen atmosphere containing oxygen at a concentration of not more than 2%. Note, however, that, in one or more UV lamp units 106_i located in the downstream portion of the primary irradiation section 106, the ultraviolet irradiation does not need to be carried out in a low-oxygen atmosphere. Specifically, provided that irradiation time of not less than 0.01 seconds is achieved by one or more UV lamp units 106_i located in the upstream portion of the primary irradiation section 106, ultraviolet irradiation by the other one or more UV lamp units 106_i located in the downstream portion of the primary irradiation section 106 may be carried out in air. In other words, an inert gas containing oxygen at low concentration does not need to be passed through such one or more UV lamp units 106_i located in the downstream portion of the primary irradiation section 106.

A reason therefor is as follows: provided that the surface layer of the ultraviolet curable resin constituting the secondary coating 12b is allowed to sufficiently cure by one or more of the UV lamp units 106_i located in the upstream portion of the primary irradiation section 106, it is no longer necessary to prevent hindering of curing caused by oxygen in the other one or more UV lamp units 106_i, because the rest of the ultraviolet curable resin is not exposed.

When such an arrangement is employed, the former part of the first irradiation step in accordance with the present invention is carried out by one or more UV lamp units 106_i that are located in the upstream portion of the primary irradiation section 106 and that carry out ultraviolet irradiation in a low-oxygen atmosphere. Next, the latter part of the first irradiation step in accordance with the present invention is carried out by the other one or more UV lamp units 106_i that are located in the downstream portion of the primary irradiation section 106 and that carry out ultraviolet irradiation in air. Then, the second irradiation step in accordance with the present invention is carried out by the secondary irradiation section 108.

In the above-described embodiments, an example has been discussed in which the coating 12 of the optical fiber wire 10 is composed of the following two layers: the primary coating 12a; and the secondary coating 12b. Note, however, that the present invention can be applied to cases where the coating 12 is composed of a single layer. In such cases, the following arrangement may be employed in one or more embodiments: the coating section 104 is configured to apply, to the optical fiber bare wire 11, an ultraviolet curable resin that forms a single-layer coating 12.

According to one or more embodiments, cooling of the optical fiber wire 10β in an area extending from the primary irradiation section 106 to the secondary irradiation section 108 is achieved by natural cooling. Note, however, that the present invention is not limited as such. Specifically, cooling of the optical fiber wire 10β in the area extending from the primary irradiation section 106 to the secondary irradiation section 108 can be achieved by forced cooling. In a case where such an arrangement is employed, a cooling section for forced cooling is provided in the area extending from the primary irradiation section 106 to the secondary irradiation section 108. The cooling section cools the optical fiber wire 10β so that the temperature of the optical fiber wire 10β immediately before entry into the secondary irradiation section 108 is not lower than 50° C. and not higher than 300° C. Note that the cooling section is constituted by, for example, a cooling cylinder through which a cooling gas flows.

According to one or more embodiments, ultraviolet irradiation in the primary irradiation section 106 is carried out by UV lamps, whereas ultraviolet irradiation in the secondary irradiation section 108 is carried out by UV LEDs. Note, however, that the present invention is not limited as such. Specifically, the ultraviolet irradiation in the primary irradiation section 106 can be carried out by UV LEDs, and the ultraviolet irradiation in the secondary irradiation section 108 can be carried out by UV lamps.

One or more embodiments of the present invention can also be expressed as follows.

A method of producing an optical fiber wire (10) in accordance with one or more embodiments of the present invention is a method of producing an optical fiber wire (10) that includes a coating (12, 12a, 12b) constituted by an ultraviolet curable resin, the method including: a first irradiation step including applying ultraviolet light to each point on the optical fiber wire (10α) in which at least a portion of the ultraviolet curable resin is in an uncured state, the portion constituting a surface layer of the coating (12b); and a second irradiation step including applying ultraviolet light to each point on the optical fiber wire (10β) which is obtained from the first irradiation step and in which at least the portion constituting the surface layer of the coating (12b) is in a cured state, wherein a temperature of the optical fiber wire (10β) immediately before the second irradiation step is not lower than 50° C. and not higher than 300° C.

An apparatus for producing an optical fiber wire (10) in accordance with one or more embodiments of the present invention is an apparatus for producing an optical fiber wire (10) that includes a coating (12, 12a, 12b) constituted by an ultraviolet curable resin, the apparatus including: a first irradiation section (106) configured to apply ultraviolet light to each point on the optical fiber wire (10α) in which at least a portion of the ultraviolet curable resin is in an uncured state, the portion constituting a surface layer of the coating (12b); and a second irradiation section (108) configured to apply ultraviolet light to each point on the optical fiber wire (10β) which is obtained by application of the ultraviolet light by the first irradiation section (106) and in which at least the portion constituting the surface layer of the coating (12b) is in a cured state, wherein a temperature of the optical fiber wire (10β) immediately before receiving the ultraviolet light from the second irradiation section (108) is not lower than 50° C. and not higher than 300° C.

According to the configuration, the optical fiber wire, in which at least the surface layer of its coating has cured in the first irradiation step (first irradiation section), has a temperature not lower than 50° C. and not higher than 300° C. immediately before entry into the second irradiation step (second irradiation section). By applying ultraviolet light to the optical fiber wire which entered the second irradiation step (second irradiation section) at a temperature falling within the above range, it is possible to allow an internal portion of the coating other than the surface layer to sufficiently cure as compared to conventional techniques. This makes it possible to reduce the frequency of cracking in the coating even if a lateral pressure acts on the coating after the production.

A method of producing an optical fiber wire (10) in accordance with one or more embodiments of the present invention may be arranged such that the temperature of each point on the optical fiber wire (10β) immediately after the first irradiation step is not higher than 300° C.

According to the configuration, it is possible to further ensure that the temperature of the optical fiber wire immediately before entry into the second irradiation step is not lower than 50° C. and not higher than 300° C.

A method of producing an optical fiber wire (10) in accordance with one or more embodiments of the present invention may be arranged such that the first irradiation step is carried out in a low-oxygen atmosphere containing oxygen at a concentration of not more than 2%.

The configuration makes it possible to prevent hindering of the curing of the ultraviolet curable resin that would otherwise be caused by oxygen.

A method of producing an optical fiber wire (10) in accordance with one or more embodiments of the present invention may be arranged such that a length of a path of advancement of the optical fiber wire (10β), from a place where the first irradiation step is carried out to a place where the second irradiation step is carried out, is set so that the optical fiber wire (10β) is allowed to naturally cool to have a temperature not lower than 50° C. and not higher than 300° C. immediately before the second irradiation step.

The configuration makes it possible to provide the foregoing effects without having to add a feature such as a cooling section.

### Supplementary Note

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 production apparatus
10 optical fiber wire
11a core
11b cladding
12a primary coating
12b secondary coating
11 optical fiber bare wire
12 coating
101 drawing section
102 cooling section
103 bare wire outer diameter measuring section
104 coating section
105 wire outer diameter measuring section
106 primary irradiation section
107 haul-off section
108 secondary irradiation section
109 take-up section
110 control section
111_1 through 111_6 pulley
106a, 108a housing
106b, 108b quartz pipe
106c UV lamp
108c UV LED bar
106a1, 106e1 gas inlet
106a2, 106f2 gas outlet
106d, 108d reflecting plate

1. A method of producing an optical fiber wire that comprises a coating made of an ultraviolet curable resin, the method comprising:
a first irradiation step comprising applying first ultraviolet light to a point on the optical fiber wire where at least a portion of the ultraviolet curable resin is uncured, wherein the portion is a surface layer of the coating; and
a second irradiation step comprising applying second ultraviolet light to the point on the optical fiber wire where at least the portion is cured after the first irradiation step,
wherein a temperature of the optical fiber wire immediately before the second irradiation step is 50° C. or higher and 300° C. or lower.

2. The method according to claim 1, wherein the temperature of the optical fiber wire immediately after the first irradiation step is 300° C. or lower.

3. The method according to claim 1, wherein a length of a path of advancement of the optical fiber wire from a place where the first irradiation step is carried out to a place where the second irradiation step is carried out is set such that the optical fiber wire naturally cools to a temperature that is 50° C. or higher and 300° C. or lower immediately before the second irradiation step.

4. The method according to claim 1, wherein the first irradiation step is carried out in a low-oxygen atmosphere containing oxygen at a concentration of 2% or less.

5. An apparatus for producing an optical fiber wire that comprises a coating made of an ultraviolet curable resin, the apparatus comprising:
a first irradiation section that applies first ultraviolet light to a point on the optical fiber wire where at least a portion of the ultraviolet curable resin is uncured, wherein the portion is a surface layer of the coating; and
a second irradiation section that applies second ultraviolet light to the point on the optical fiber wire where at least the portion is cured by application of the first ultraviolet light,
wherein a temperature of the optical fiber wire immediately before receiving the second ultraviolet light 50° C. or higher and 300° C. or lower.

6. The method according to claim 1, wherein
the first ultraviolet light is emitted by an ultraviolet lamp, and
the second ultraviolet light is emitted by an ultraviolet light emitting diode.

7. The apparatus according to claim 5, wherein
the first ultraviolet light is emitted by an ultraviolet lamp, and
the second ultraviolet light is emitted by an ultraviolet light emitting diode.
